(19) United States
(12) Patent Application Publication
(10) Pub. No.: US 2020/0334560 A1
(43) Pub. Date: Oct. 22, 2020

(54) METHOD AND SYSTEM FOR DETERMINING AND USING A CLONED HIDDEN MARKOV MODEL

(71) Applicant: Vicarious FPC, Inc., Union City, CA (US)

(72) Inventors: Nishad Gothoskar, Union City, CA (US); Dileep George, Union City, CA (US); Miguel Larzaro-Gredilla, Union City, CA (US)

(21) Appl. No.: 16/853,539

(22) Filed: Apr. 20, 2020

Related U.S. Application Data
(60) Provisional application No. 62/835,782, filed on Apr. 18, 2019.

(51) Int. Cl. G06N 7/00

(52) U.S. Cl. CPC G06N 7/005

(57) ABSTRACT

The system and method for determining and using a cloned hidden Markov model (CHMM) preferably including: determining an initial CHMM, learning a final CHMM, and using the final CHMM, wherein the CHMM includes a transition probability data structure and an observation probability data structure.

### CROSS-REFERENCE TO RELATED APPLICATIONS

This application claims the benefit of U.S. Provisional Application Ser. No. 62/835,782, filed on 18 Apr. 2019, which is incorporated in its entirety by this reference.

### TECHNICAL FIELD

This invention relates generally to the artificial intelligence field, and more specifically to a new and useful system and method for reinforcement learning in the artificial intelligence field.

### BACKGROUND

Cognitive maps enable humans and animals to learn the layout of environments, encode and retrieve episodic memories, and navigate vicariously for mental evaluation of options. However, there does not exist a satisfactory model and/or common framework for representing cognitive maps. In particular, conventional models are unable to explain how cognitive maps can be learned scalably with sensory observations that are non-unique over multiple spatial locations (aliased), retrieved efficiently under uncertainty, and used for hierarchical planning.

### BRIEF DESCRIPTION OF THE FIGURES

FIG. 1 is a schematic representation of the method.

FIG. 2 is a schematic representation of an embodiment of the system.

FIGS. 3A-C depict embodiments of the system.

FIG. 4 depicts an embodiment of the method.

FIG. 5 depicts a specific example of S200.

FIGS. 6A-B depict specific examples of S200.

FIG. 7 depicts a specific example of S200 and S300.

FIG. 8 depicts a specific example of S300.

FIG. 9 depicts a variant of S200 and S300.

FIG. 10 depicts examples of S200 and S300.

FIG. 11 depicts a specific example of S200 and S300.

FIG. 12 depicts an example of S200.

FIG. 13 depicts a variant of S200 and S300.

FIG. 14 depicts a variant of S200 and S300.

FIG. 15 depicts a variant of hierarchical learning.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

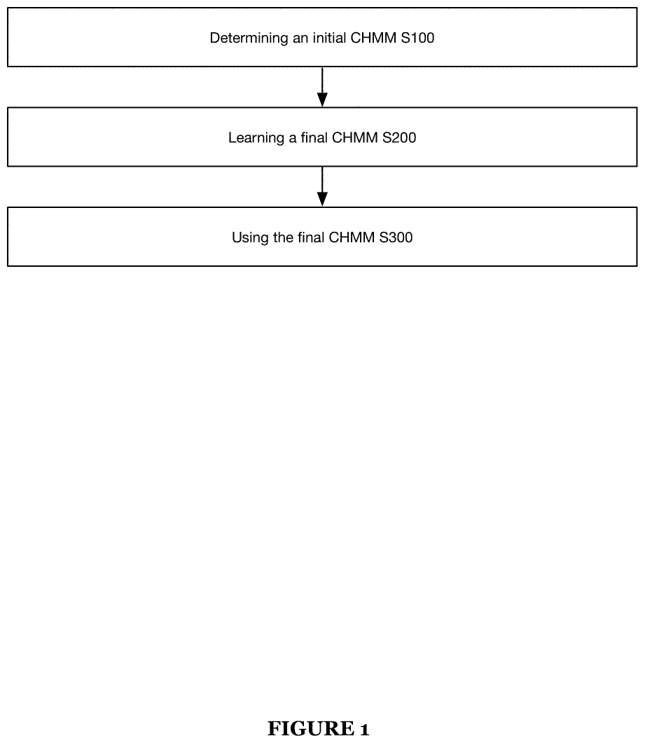

The method, as shown in FIG. 1, for determining and using a cloned hidden Markov model (CHMM) preferably includes determining an initial CHMM S100, learning a final CHMM S200, and using the final CHMM S300, but the method can additionally or alternatively include any other suitable elements. The method preferably functions to determine a representational structure of an environment, but can additionally or alternatively function to determine query results using the representational structure of the environment, and/or perform any other suitable functionality.

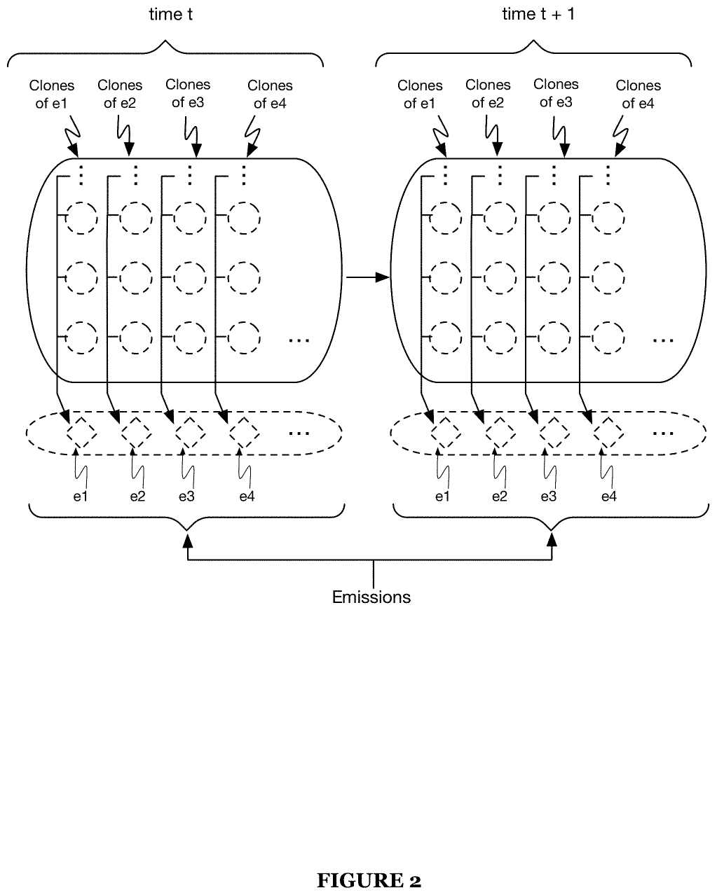

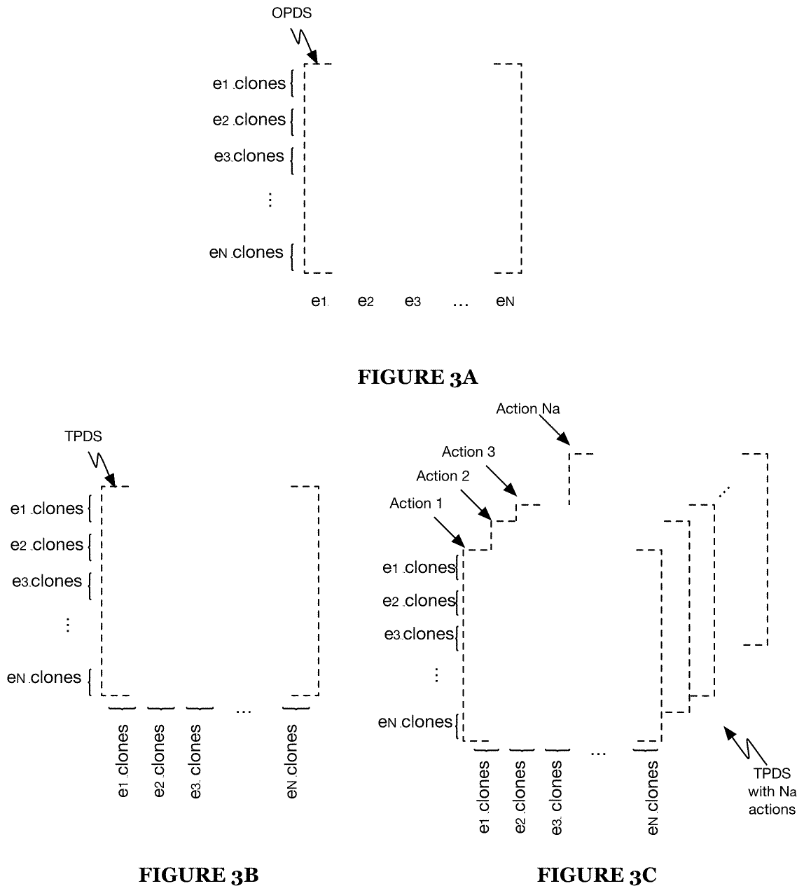

The system for determining and using a CHMM can include one or more computing systems and one or more CHMMs, but can additionally or alternatively include any other suitable elements. Variants of the system are depicted in FIGS. 2 and 3A-C.

### 2. Examples

In a first example, the method and system include determining a set of emissions, hardcoding an observation probability data structure (OPDS) with the set of emissions and a plurality of clones, initializing a transition probability data structure (TPDS), which includes probabilities representing a transition from a current clone to a next clone, freezing the hardcoded OPDS, learning a final TPDS by receiving an input sequence (e.g., from an agent moving in an environment) and using the hardcoded OPDS and the input sequence to update the initial TPDS (e.g., update the transition probabilities between clones), and using the final TPDS and hardcoded OPDS as the final CHMM during inference.

In a second example, as depicted in FIG. 2, the system and method includes the CHMM at different timesteps. Different sets of clones map deterministically to a respective emission. Each different set of clones cooperatively form a plurality of clones. At a particular timestep during learning, one or more clones can be activated (e.g., selected to represent a location of a train environment) based on a received observation of an emission. The single clone is activated based on contextual information, historical information, and/or any other suitable information associated with the environment. During inference, the same CHMM (e.g., the same ODPS and learned TDPS) are used to determine the environment location for each time step.

In a third example, the system and method include one or more elements described in “Learning cognitive maps for vicarious evaluation”, published on 9 Jan. 2020, which is incorporated herein in its entirety by this reference.

In a fourth example, the system and method include one or more elements described in “Learning higher-order sequential structure with cloned HMMs”, published on 15 May 2019, which is herein incorporated in its entirety by this reference.

### 3. Benefits

The system and method confer several benefits over conventional systems.

First, the system and method include a cloned hidden Markov model (CHMM), that is easy to train, scale, and perform inference on. The CHMM enables efficient learning from experienced sequences. The CHMM includes a sparse and hardcoded OPDS that enables faster learning than conventional models, which require the OPDS be learned during training. Further, the OPDS includes a mapping from different sets of clones to single emissions, which enables the CHMM to embed history into a first order model, wherein the CHMM is a first order model. Otherwise, to embed history, higher order models are required, which are more computationally expensive.

Second, the CHMM representation described in the system and method provides several benefits over existing models. The CHMM representation provides a storage and representational structure that supports transitivity; enables efficient context-sensitive and probabilistic retrieval; enables learning of hierarchies that support efficient planning (e.g., by treating lower-level CHMMs representing subgraphs or lower-level hierarchies as emissions, and learning a higher-level CHMM representing relationships between the lower-level CHMMs); provides separate access to the present and the predicted future, while preserving ordering; provides a learning mechanism to extract higher-order graphs from sequential observations; handles uncertainty, noise, and aliasing in observations, which includes enabling tractable inference; enables on-the-fly policy updates when a reward is changed, which includes capturing the dynamics of the environment as opposed to being a function of policy; alleviates credit diffusion problem typically associated with hidden Markov models (HMM), which is enabled by the sparsity structure of the OPDS including a fixed, known association clones of the CHMM that represent one or more hidden states and specific observations, with each clone being associated with a single emission or alternatively multiple emissions; and/or other functionalities.

Third, the system and method enable computation savings compared to existing solutions. Conventional models require updating the entire TPDS during training. The inventor's discovered that since the OPDS is hardcoded and fixed during training of the TPDS, only sub-sections of the TPDS are necessary to update during an iteration of the EM algorithm. In other words only a set of sub-subsections of the TPDS are updated at each iteration, which is enabled because the OPDS is hardcoded.

Further, training CHMMs is easier (less learning iterations) compared to an HMM because the OPDS is known and fixed a priori, and cheaper (less cost per iteration for a given number of clones) enabled by the sparsity of the OPDS (and potentially the TPDS).

Fourth, the system and method enable memory savings by not storing entries in the TPDS if the transition does not exist (e.g., using Viterbi decoding with no pseudocount).

Fifth, the system and method generates a representational structure that aids learning, retrieval of episodes, and memory integration.

Sixth, the system and method enables spatial map discovery from random walks under aliased and disjoint sensory experiences, transferable structural knowledge, finding shortcuts, hierarchy determination, and hierarchical planning, and physiological findings such as remapping of place cells, and route-specific encoding.

However, the method and system can confer any other suitable benefits.

### 4. System

The method is preferably performed using the system, including: one or more computing systems (e.g., remote computing system, such as a server system, distributed computing system, etc.) and one or more CHMMs, but can additionally or alternatively include any other suitable elements.

The system can be used with one or more environments, one or more emissions, one or more observations, one or more actions, one or more clones, and/or any other suitable elements.

The environment can be virtual or physical, such as space (e.g., 2D, 3D, such as a room, maze, etc.), a node graph (e.g., factor graph, directed graph, undirected graph, etc.), text (e.g., a book, a poem, a paragraph, a sentence, etc.), and/or any other suitable environment.

The environment can include one or more locations. The locations and/or one or more location parameters (e.g., inter-location relationships, number of locations, etc.) are preferably initially unknown (e.g., are hidden states), wherein the CHMM learns the locations (e.g., as the clones) and/or location parameters (e.g., as the TDPS, extracted from the learned TDPS) through training. One or more location parameters (e.g., number of hidden states per emission) can be known pre-training, be determined through learning, or otherwise determined. However, the location and/or location parameters can be otherwise determined.

Each location can be associated (e.g., deterministically associated) with an emission, wherein an observation of the location (e.g., a measurement of the location) results in an emission. The emission need not be unique (e.g., wherein the resultant observations of different locations can be aliased), but can alternatively be unique (e.g., locally unique to the environment). Each location can optionally be associated with a set of possible agent actions that can be performed at the location; alternatively, the location can be associated with a set of agent actions that cannot be performed at the location. Examples of locations include: spatial position, conceptual node in a node graph, letter in a word, word in a phrase, section in a document, lower-level CHMM, and/or other locations.

The environment can be a train environment, an inference environment, and/or any other suitable environment. The inference environment can be the train environment, can be a new environment that includes a set of locations of all possible locations of the train environment (e.g., some locations can be blocked), can include all possible locations of the train environment, wherein each location is associated with new, different observations. Each location of the inference location can be associated with the same actions, wherein each action yields the same next location as the actions of the train environment, but can additionally or alternatively be associated with new actions that yield different next locations.

The location can be a hidden state. The hidden state can be hidden during learning and inference and inferred using the learned CHMM. The number of hidden states can be known, but can alternatively be unknown. The hidden state can have a fixed, known, deterministic association with an emission, wherein each hidden state is associated with a single emission.

In a first example, the hidden state is a discrete physical location within a physical space.

In a second example, the hidden state is a discrete node within a hierarchy.

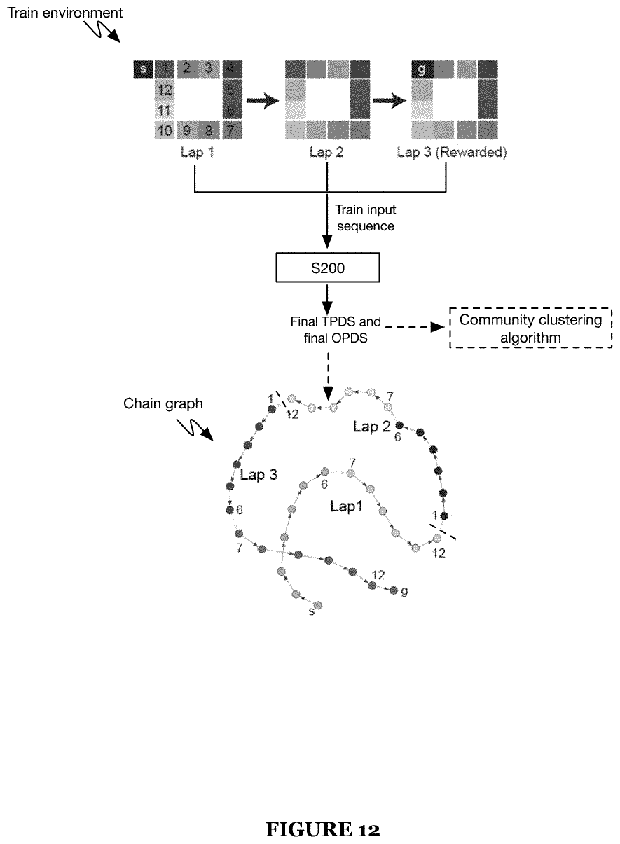

In a third example, the same hidden state can be associated with different context and/or policy (e.g., the same location in a train environment including a circuit is represented as different clones within the CHMM because the rewards received when visiting the hidden state at different timesteps is different, such as for completing a lap in the circuit versus completing the full circuit including multiple laps). An example of an environment including a circuit is depicted in FIG. 12.

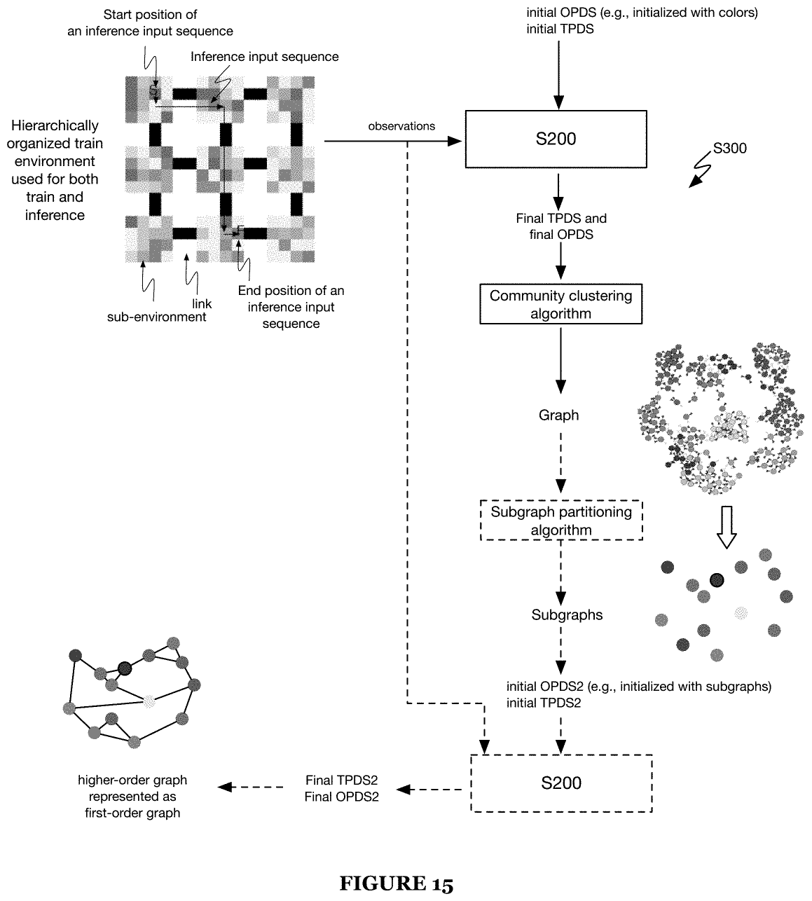

In a fourth example, the hidden state can be a CHMM, subgraph, or lower-level hierarchy (example shown in FIG. 15).

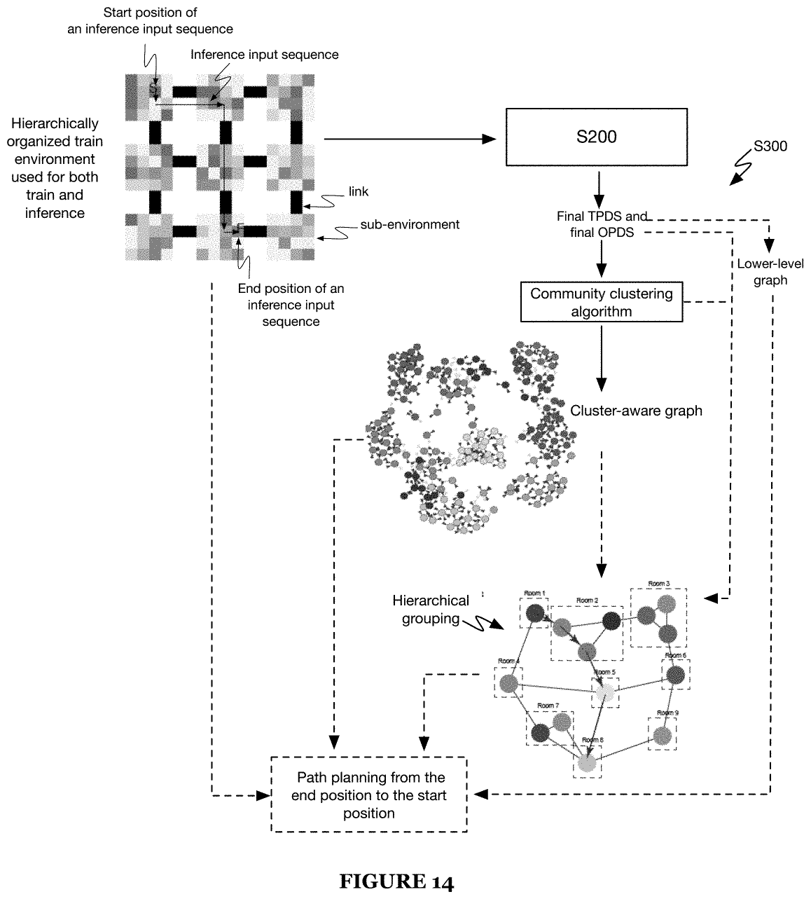

The environment can have an underlying hidden hierarchy, or have no hidden hierarchy. A train environment that is hierarchical (includes a hidden hierarchy) can include a plurality of connected sub-environments connected by one or more links (e.g., corridor, edges, bridges, etc.). Each sub-environment can include aliased observations (e.g., multiple observation instances that map to the same emission can be associated with locations in multiple different sub-environments), unique observations, and/or other observations. A specific example of a hierarchical train environment that includes a plurality of sub-environments is depicted in FIG. 14.

In a first example, an environment can be a room with tiles wherein each tile is a location, and wherein each tile can be associated with one or more unique sensory observations, such as colors.

An environment can be explored using one or more processes performed by an agent. The one or more processes can include stochastic processes, predetermined processes, a random process, predetermined process (e.g., a series of actions), and/or any other suitable process. The one or more processes can determine a path (or walk), which can include a succession of steps taken by the agent in the environment.

However, an environment can additionally or alternatively include any other suitable elements.

The system can be used with one or more emissions. An emission and/or signal (e.g., sensory input) can be output by an agent observing a hidden state. With cloning, the same bottom-up sensory input (e.g., emission) can be represented by multiple clones that are copies of each other in their selectivity for the sensory input, but specialized for specific temporal contexts. Each environment can be associated with a set of emissions. The set of emissions associated with the environment can be known, unknown, learned (e.g., unique emissions extracted from a set of observations), or otherwise determined. An emission can be discrete or continuous. Examples of emissions include: categories, labels, and/or any other identifier. Specific examples of emissions include: color, number, temperature, character, subgraphs, CHMMs, and/or any other suitable sensory input.

The system can be used with one or more observations. An observation is preferably an emission instance or measurement determined by an agent while exploring and/or traversing an environment. An observation can be part of an ordered series of observation. An example of ordered series of observations includes observations observed by an agent exploring an environment, such as using a stochastic process.

Examples of observations can include: spatial observations; sensor observations; odors; character sequences; word sequences; grid cells; path integration signals; phenomenon observations; subgraph identifiers (e.g., parent nodes of subgraphs); and/or any other suitable observation.

However, an observation can additionally or alternatively include any other suitable elements.

The system can be used with one or more actions. An action can be performed by an agent. An action can be predetermined (e.g., hardcoded, received from an entity, determined in a prior process, etc.), learned (e.g., unique actions within a stream of actions), or otherwise determined. An action can be represented by nonnegative integers with unknown semantics, but can additionally or alternatively be represented by negative integers, real numbers, characters, symbols, and/or any other suitable representation. An action can be received as part of or in addition to an input sequence or stream including received observations. However, an action can additionally or alternatively include any other suitable elements.

The system can be used with one or more rewards. A reward can be observed and/or received by an agent. A reward can be represented by nonnegative integers with unknown semantics, but can additionally or alternatively be represented by negative integers, real numbers, characters, symbols, and/or any other suitable representation. A reward can be received as part of or in addition to an input sequence or stream. However, a reward can additionally or alternatively include any other suitable elements.

The system can be used with one or more clones. A clone is preferably representative of a hidden state. A clone is not necessarily context- or sequence-dependent (e.g., like a dynamic Markov model), but enables context and sequences to be determined. A clone is preferably deterministically associated with an emission, but can be probabilistically associated with an emission (e.g., to incorporate sensor noise) or be otherwise associated. Each clone is preferably associated with a single emission, but can alternatively be associated with multiple emissions. The system preferably includes multiple clones that map deterministically to the same observed emission. The number of clones can be at least the number of hidden states associated with the emission, but can be equal to the number of hidden states, less than the number of hidden states, or otherwise related to the number of hidden states. However, a clone can additionally or alternatively include any other suitable elements.

The system preferably includes a CHMM, which is preferably a first order probabilistic sequence model that uses sequential information to model an environment. The sequential information can include one or more input sequences. The input sequences can include train input sequences (e.g., learning a final TPDS and/or a final OPDS), inference input sequences (e.g., querying the final CHMM), and/or any other suitable input sequences. The input sequences can include observations, actions, rewards, and/or any other suitable information. The input sequences can include an observation associated with the current location, observations associated with one or more neighboring locations to the current location, and/or any other suitable information.

The CHMM can include one or more OPDSs and one or more TPDSs, but can additionally or alternatively include any other suitable elements. The OPDS and TPDS are preferably arrays (e.g., matrix, 1 dimensional, 2 dimensional, 3 dimensional, N dimensional, etc.), but can additionally or alternatively be linked lists, records, and/or any other suitable data structures.

The OPDS functions to relate the emissions within a set of emissions to the respective emissions' clones. The OPDS can additionally be used to determine an index mapping for updating the TPDS and/or sub-structures (e.g., sub-arrays) of the TPDS during training.

The OPDS preferably includes a set of emission probabilities, wherein each emission probability represents a probability of observing the emission when in the hidden state associated with the respective clone. Each emission probability preferably represents P(eᵢ|cᵢ), wherein eᵢ is the emission eᵢ associated with clone cᵢ. In one variation, the emission probability can be distributed 1.0 for the associated emission and o for all other emissions. In a second variation, when sensor noise is incorporated into the distribution, the emission probabilities can be distributed to represent a true positive, a true negative, a false positive, and a false negative, the probabilities can be distributed to represent disambiguation between multiple emissions (e.g., disambiguation between 2 emissions, 3 emissions, etc.). For example, when a sensor correctly identifies a red tile as “red” 95% of the time (e.g., true positive probability), the emission probability for the red tile's clone and “red” (e.g., the emission) can be 0.95. In this example, the remaining probability (e.g., 5%) can be: evenly distributed across the other emissions (e.g., wherein the probability between the red tile's clone and N other colors is 0.05/N); distributed across false positive emissions (e.g., the emission probability between the red tile's clone and “orange” can be 0.05 when the sensor incorrectly identifies a red tile as “orange” 5% of the time); or otherwise determined. Additionally or alternatively, the set of emission probabilities of the OPDS can be modified to correct errors in corrupted sequential information (e.g., trained input sequence and/or inference input sequence) by assigning a small probability to a random emission from a given clone to model errors (sensor noise).

However, the clone-emission probabilities can be otherwise determined.

The OPDS is preferably hardcoded (e.g., the set of emission probabilities is pre-determined), but can alternatively be learned or otherwise determined.

The OPDS can be an array, a matrix, and/or any other suitable data structure. In a first variant, the OPDS is a two-dimensional matrix, wherein the first dimension of the OPDS represents a set of emissions and the second dimension of the OPDS represents the plurality of clones.

The set of emissions preferably includes E emissions (e.g., 2, 3, 4, 5, 6, 7, 8, 9, 10, 20, 30, 40, 50, 100, etc.). The set of emissions can be predetermined (e.g., received from a manufacturer, known based on the train environment, etc.). Each received observation sequence can include one or more unique emissions of the set of emissions.

The plurality of clones preferably includes a total number of clones, C. The total number of clones C=M₁+M₂+M₃ . . . , where Mⱼ is equal to the number of clones per emission j. M₁ can be the same as or different from M₂. In a first variant, if each emission is assigned M clones, then C is equal to E multiplied by M, where M can be 10, 20, 30, 40, 50, 60, 70, 80, 90, 100, 200, 300, 400, 500, 1000, and/or any other suitable number of clones. In a second variant, each emission (or a subset thereof) can be associated with a different number of clones (e.g., a first emission can be associated with 60 clones, a second observation can be associated with 100 clones, etc.). Each emission is preferably associated with enough clones to model a train environment, wherein each clone is associated with a single hidden state, but additionally or alternatively multiple clones can be associated with the same hidden state.

The OPDS is preferably overcomplete (e.g., the number of emissions E is less than than the number of clones C; the number of hidden states S per emission j is less than the number of clones for the emission j), but can alternatively be complete (e.g., the number of hidden states S per emission j is equal to the number of clones for the emission j), or have any other suitable relationship between the number of emissions, the number of hidden states, and the number of clones.

The OPDS is preferably sparse (e.g., the number of zero-valued elements divided by the number of elements is greater than a threshold value, such as greater than 0.4, 0.5, 0.6, 0.7, 0.8, 0.9, etc.), but can alternatively be dense. Values for every cell in the array can be stored, or the zero-valued elements can be removed or not stored, which enables memory savings.

The OPDS can be representative of one or more related or disjoint train environments. The related train environments can be: overlapping, linked, hierarchically related, or otherwise related.

A variant of the OPDS is depicted in FIG. 3A, wherein the set of emissions include e₁-e_{N}, and each emission is associated with a different set of clones (e.g., e₁ clones, e₂ clones, etc.).

However, the OPDS can additionally or alternatively include any other suitable information.

The CHMM can include one or more TPDSs, which function to determine transition probabilities from a current clone to adjacent clones accessible from the current clone.

The TPDS preferably includes a set of transition probabilities representing a probability of transitioning from a current clone to the next clone of the plurality of clones. The transition probabilities can be represented as P(cᵢ|cⱼ) wherein cⱼ represents the current clone and cᵢ represents the next clone of the plurality of clones, where C is the number of clones in the plurality of clones.

The set of transition probabilities can be initialized randomly (e.g., random number between o−1, such as using a random number generator), but can additionally or alternatively be initialized uniformly (e.g., 0.1, 0.2, 0.3, 0.4, 0.5, 0.6, etc.), initialized to a predetermined value, or otherwise initialized. In one variation, after learning, the transition probabilities of the set of transition probabilities associated with transitions that are not observed in the environment are not stored, which enables memory savings and increases the speed of learning the TPDS. In a second variant, the transition probabilities of unobserved transition can be retained within the TPDS.

The set of transition probabilities can be values between 0-1, but can additionally or alternatively be binary values or other values.

The set of transition probabilities can be learned, hardcoded, and/or otherwise determined.

In variants when the TPDS includes actions, the set of transition probabilities can additionally include the probability of transitioning to a next clone based on a current clone and the action taken from the current clone (e.g., the transition probability is dependent on the current clone and the action taken). Additionally or alternatively, the set of transition probabilities includes the probability of performing an action form a current clone.

The TPDS can include two or more dimensions.

In a first variant, the TPDS is two or more dimensions, wherein the number of dimensions represents the number of variables that influence the subsequent state.

In a first embodiment, the TPDS includes two dimensions and the size of the TPDS is C×C.

In a second embodiment, the TPDS is three dimensions, wherein a first and second dimension are associated with the plurality of clones and the third dimension is associated with a set of actions. In a first example, when either no actions are available or one action is available, the size of the TPDS is C×C×1. In a second example, when 3 actions are available, the size of the TPDS is C×C×3. In a third example, when N_{α} actions are available, the size of the TPDS is C×C×N_{α}. A variant of the TPDS with N_{α} actions is depicted in FIG. 3C.

Alternatively, different TPDSs can be associated with different actions, wherein a TPDS is selected for use based on a performed action at a current state (e.g., received in the sequential information). However, the set of actions can additionally or alternatively be otherwise represented and accounted for.

The TPDS can be organized such that the clones of the first emission of the set of emissions appear first, the clones associated with the second emission appear second, and so on, such as depicted in FIG. 3B. Alternatively, the TPDS can be organized randomly such that the clones of the first emission do not necessarily appear first. However, the TPDS can additionally or alternatively be otherwise organized.

The TPDS can be representative of one or more related and/or disjoint train environments.

However, the TPDS can additionally or alternatively include any other suitable elements.

However, the system can additionally or alternatively include any other suitable elements.

### 5. Method

The method for determining and using a CHMM can include: determining an initial CHMM S100, learning a final CHMM S200, and using the final CHMM S300, but can additionally or alternatively include any other suitable elements.

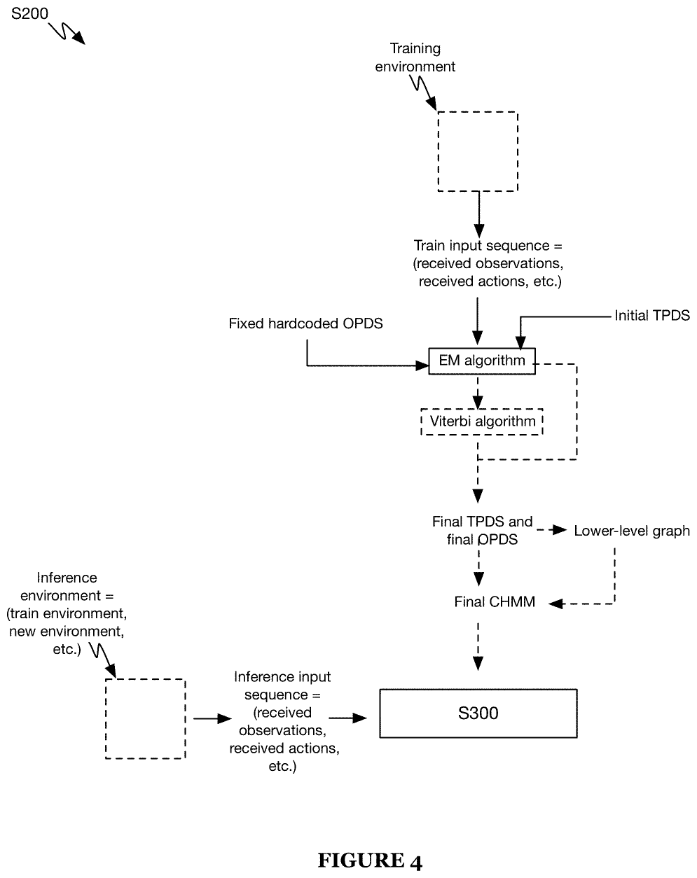

In a first embodiment of the method, as depicted in FIG. 4, the method can include receiving a train input sequence that is based on a train environment, using the train input sequence and a fixed hardcoded OPDS to learn a final TPDS with a EM algorithm, optionally removing duplicate clones of the TDPS using a Viterbi algorithm, optionally determining a (lower-level) graph based on the final TPDS and/or the final OPDS (e.g., fixed, hardcoded OPDS, learned OPDS, etc.), and using the final CHMM including the final TPDS, the final OPDS, and/or the (lower-level) graph to preform inference (e.g., on an inference environment used to generate an input sequence).

Determining an initial CHMM S100 functions to determine an initial OPDS and an initial TPDS. Determining the initial CHMM can include determining an initial OPDS, which can include determining a set of emissions associated with a train environment. The set of emissions preferably includes E emissions (e.g., unique observations), but can additionally or alternatively include any suitable number of emissions. The set of emissions can be manually determined, automatically determined, estimated, and/or otherwise determined. In a first variant, the set of emissions can be determined from a train input sequence including observations associated with unique emissions. In a second variant, the set of emissions can be received from an entity. However, the emission set can be otherwise determined.

Determining an initial OPDS can include determining a number of clones Mⱼ per emission j of the set of emissions. Mⱼ is preferably greater than or equal to the number of hidden states associated with emission j, but Mⱼ can additionally or alternatively be less than the number of hidden states associated with emission j.

Determining an initial OPDS can include initializing the OPDS of size E×C, wherein C is the number of clones of the plurality of clones and E is the number of emission of the set of emissions. Alternatively, determining an initial ODPS can include initializing an OPDS with Mⱼ clones for each emission j.

In a first variant, initializing the OPDS can include hardcoding the OPDS.

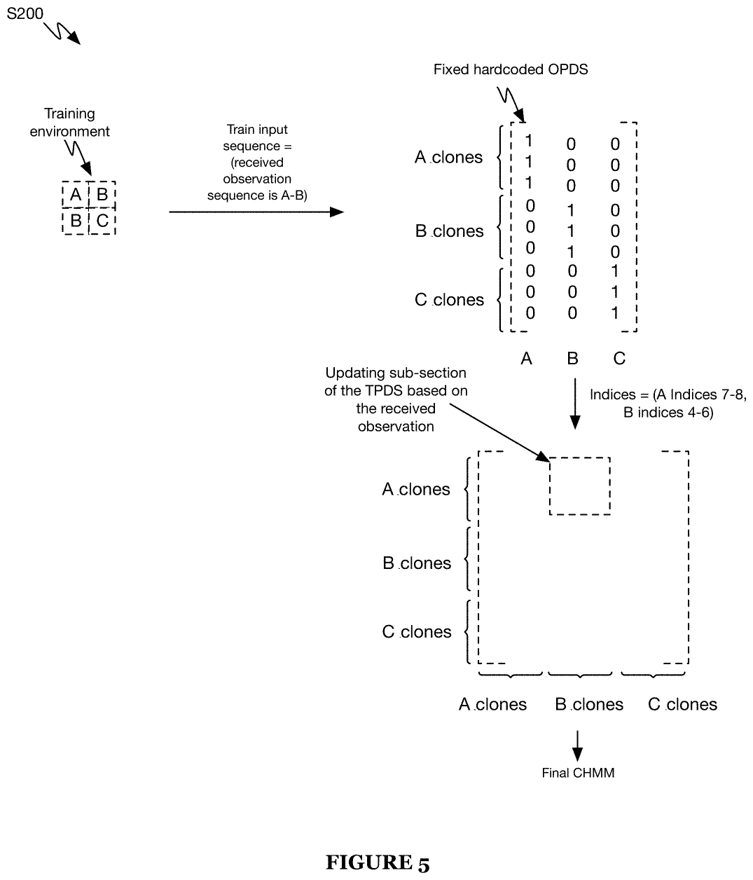

In a first example, hardcoding the OPDS can include assigning the clones of emission j to the emission by hardcoding a 1 for each clone of the emission and o for all clones associated with different emissions. A specific example is depicted in FIG. 5.

In a second example, hardcoding the OPDS can include assigning the clones of emission j to the emission by hardcoding a probability (e.g., 0.99, 0.98, 0.97, 0.96, 0.95, etc.) for each clone of the observation and distributing the remaining value (e.g., 0.01, 0.02, 0.03, 0.04, 0.05, etc.) to the other clones of the other emissions. The hardcoded probability can be determined based on sensor noise of sensors mounted to an agent (e.g., used to determine an input sequence).

In a first embodiment, the hardcoded probability is sensor noise.

In a second embodiment, the hardcoded probability is calculated from sensor noise. Determining sensor noise can include sampling the sensors and determining if the measured signal is accurate and/or inaccurate, receiving the sensor noise from a manufacturer, and/or the sensor noise can be otherwise determined.

In a second variant, determining the initial OPDS can include setting the set of emission probabilities of the initial OPDS randomly between o−1 (e.g., such that the initial OPDS as well as the initial TPDS can be learned in S200). However, determining the initial OPDS can additionally or alternatively include any other suitable elements.

Determining the initial CHMM S100 can include determining an initial TPDS, which can function to initialize the TPDS for learning the transition probabilities in S200. Determining the initial TPDS can include randomly initializing the transition probabilities to values between o−1, but can additionally or alternatively include uniformly initializing the transition probabilities (e.g., 0.1, 0.2, 0.3, 0.4, 0.5, etc.).

In a first variant, initializing the TPDS can include initializing an array of size C×C with random transition probabilities. In this variant, each clone in the learned CHMM (learned using this TPDS) can represent a different hidden state.

In a second variant, initializing the TPDS can include initializing the TPDS with actions, such that the array is of size C×C×N_{α} wherein N_{α} is the number of actions. An example is depicted in FIG. 3C.

In a first embodiment, each probability of the set of transition probabilities in the learned CHMM (learned using this TPDS) represents the probability of transitioning to a next hidden state given a current (neighboring) hidden state and a current action taken from the current hidden state to arrive at the next hidden state. In other words, the next state is based on the current state and the action performed from the current state.

In a second embodiment, each probability of the set of transition probabilities in the learned CHMM (learned using this TPDS) represents both the probability of a next hidden state given a current (neighboring) hidden state and a current action taken from the current hidden state to arrive at the next hidden state and the probability of performing a particular action from the current hidden state. In other words, the probability of the next state is based on the current state and the action performed from the current state, and the probability of the action is based on the current state (e.g., of the actions possible from the current state). However, the CHMM can be otherwise initialized.

Learning a final CHMM S200 functions to iteratively update the initial TPDS based on one or more input sequences observed from a train environment.

S200 can include: freezing the initial (e.g., hardcoded) OPDS and iteratively updating the TPDS based on train input sequences. However, S200 can include: freezing a prelearned TPDS and iteratively updating the ODPS based on train input sequences, or be otherwise performed.

Learning the final CHMM can include iteratively updating the TPDS to determine the final TPDS. Iteratively updating the TPDS can include receiving one or more train input sequences and updating the TPDS based on the received train input sequences, but can additionally or alternatively include any other suitable elements.

The one or more train input sequences can be a sequence of received observations (multiple ordered observations), sequence of received actions, sequence or received observations and actions, sequence of received observations, actions, and rewards, and/or any other suitable combination of received observations, actions, and rewards. Each sequence can be associated with (e.g., determined from) the train environment. Different train input sequences can be associated with the same or different train environments. When different train input sequences are associated with different train environments, the TPDS can learn the different train environments (e.g., with or without indication that the different train input sequences are associated with different train environments).

In one example, the one or more train input sequences can be determined from a physical environment and can be received from one or more sensors mounted to a physical agent, wherein the physical agent can be performing one or more processes to explore a physical train environment. In a second example, the one or more train input sequences can be determined from a virtual environment and can be received from a virtual agent, wherein the virtual can be performing the one or more process to explore a virtual train environment. However, the train input sequence can be manually determined and/or otherwise determined.

Each received observation of the train input sequence preferably maps to an emission (e.g., the measurement has a value associated with an emission of the set of emissions). The observation-emission mapping is preferably deterministic, but can alternatively be probabilistic.

In a first variant, the received train input sequence can include: (x_{1,}, x_{2,}, . . . , x_{N-1,}, x_{N,}) where each xᵢ maps to one of the emissions of the set of emissions. Additionally or alternatively, one or more xᵢ can map to two or more emissions and a process can be used to determine a single emission from the two or more emissions. The process can include evaluating an observation based on threshold, evaluating an observation based on an expected value, and/or any other suitable process.

In a second variant, each received observation can include an associated action: (x_{1,},α₁), (x_{2,}, α₂), . . . , (x_{N-1,},α_{N-1}), (x_{N,}, -) where each xᵢ maps to one of the emissions of the set of emissions, wherein (x_{N,}, -) is the last observation of the sequence (no actions follow x_{N}), and each αᵢ is an action of the set of actions. In variants, αₖ∈Z* are actions reported by agent's proprioception at time k, where Z* represents the set of actions.

Learning the final TPDS can include updating the initial TPDS based on the one or more received input sequences.

In a first variant, updating the initial TPDS can include updating a sub-section of the initial TPDS by determining indices of a sub-section of the initial TPDS using the fixed OPDS, wherein the indices represent clones that are associated with emissions that map to observations of the train input sequence.

In a first example, updating the initial TPDS can include receiving the input sequence determined from a train environment. The fixed hardcoded OPDS can be used to determine a first set of indices of clones that map to a first emission and a second set of indices of clones that map to a second emission. The first and second set of indices can be used to update a sub-section of the TPDS, rather than the entire TPDS. A specific example is depicted in FIG. 5.

In a second variant, updating the initial TPDS can include updating the entire TPDS.

Updating the initial TPDS can be performed using an expectation-maximization (EM) algorithm, which functions to iteratively find maximum likelihood or maximum a posteriori (MAP) estimates of the set of transition probabilities based on the one or more train input sequences until convergence is reached (e.g., small changes, such as 0.01, 0.02, 0.03, etc., between transition probabilities, between multiple iterations, such as 5, 10, 15, 20, etc.). However, the TPDS can be determined using a Baysean method, majorize-minimization (MM) algorithm, an optimization algorithm, and/or other methods.

The EM algorithm includes and E-step and an M-step. The E-step can function to estimate missing transition probabilities. The M-step can function to optimize the transition probabilities to explain the train input sequence.

In a first variant, the Baum-Welch equations can be used to update the initial TPDS to determine the final TPDS. The sparsity of the OPDS enables sub-section updates to the TPDS in both the E- and the M-steps of the Baum-Welch equations. Updating the initial TPDS using the Baum-Welch equations can include optimizing a vector of prior probabilities π: πᵤ=P(z₁=u) and optimizing the TPDS T: Tᵤᵥ=P(zₙ₊₁=ν|zₙ=u) wherein zₙ is a variable that represents the hidden state at timestep n and xₙ represents an emission associated with zₙ. The TPDS T can be broken down into smaller sub-sections T(i, j),i, j∈1 . . . E, where E is the number of emissions of the set of emissions. The submatrix T(i, j) contains the transition probabilities P(zₙ₊₁|zₙ) for zₙ∈hid(i) and zₙ₊₁∈hid(j), wherein hid(i) and hid(j) respectively correspond to the clones of observations i and j respectively. The E-step of the Baum-Welch equations recursively computes the forward and backward probabilities and updates the posterior probabilities of the TPDS. The M-step of the Baum-Welch equations updates the TPDS using row normalization. A specific example of the Baum-Welch equations are as follows:

$$\begin{matrix}α ( 1 ) = π ( {x}_{1} ) \\ {α ( n + 1 )}^{⊤} = {α ( n )}^{⊤} T ( {x}_{n} , {x}_{n + 1} ) \\ β ( N ) = 1 ( {x}_{N} ) \\ β ( n ) = T ( {x}_{n} , {x}_{n + 1} ) β ( n + 1 ) \\ {ξ}_{ij} ( n ) = \frac{α ( n ) ∘ T ( i , j ) ∘ {β ( n + 1 )}^{⊤}}{{α ( n )}^{⊤} T ( i , j ) β ( n + 1 )} \\ γ ( n ) = \frac{α ( n ) ∘ β ( n )}{{α ( n )}^{⊤} β ( n )} . & E \text{-} Step \\ π ( {x}_{1} ) = γ ( 1 ) \\ T ( i , j ) = {\sum }_{n = 1}^{N} {ξ}_{ij} ( n ) ∅ {\sum }_{j = 1}^{E} {\sum }_{n = 1}^{N} {ξ}_{ij} ( n ) . & M \text{-} Step\end{matrix}$$

Where | and Ø denote elementwise product and division, respectively. In this example, all vectors are M×1 column vectors, where M is the number of clones per emission.

In a second variant, the EM algorithm can be used to update the initial OPDS (e.g., randomly initialized) and determine a final OPDS using the above described EM algorithm and Baum-Welch equations by fixing the TPDS and updating the OPDS instead (e.g., replacing the TPDS with the OPDS in the Baum-Welch equations). Additionally or alternatively, the OPDS can be re-initialized after learning the final TPDS, in which case the final TPDS is fixed and the final OPDS is learned using the EM algorithm. The final OPDS can be determined based on the training environment, based on a new environment that is structurally similar to the training environment, and/or otherwise determined.

In a third variant, when the TPDS includes actions (TPDS is action augmented), actions can occur at each timestep (conditional on the current hidden state). The actions can be grouped with the next hidden state, to remove potential loops and create a chain that is amenable to exact inference. The description of the Baum-Welch equations from the first variant apply to the action-augmented TPDS. A specific example of the action-augmented Baum-Welch equations are as follows:

$$\begin{matrix}α ( 1 ) = π ( {x}_{1} ) \\ {α ( n + 1 )}^{⊤} = {α ( n )}^{⊤} T ( {x}_{n} , {a}_{n} , {x}_{n + 1} ) \\ β ( N ) = 1 ( {x}_{N} ) \\ β ( n ) = T ( {x}_{n} , {a}_{n} , {x}_{n + 1} ) β ( n + 1 ) \\ {ξ}_{ikj} ( n ) = \frac{α ( n ) ∘ T ( i , {a}_{n} , j ) ∘ {β ( n + 1 )}^{⊤}}{{α ( n )}^{⊤} T ( i , {a}_{n} , j ) β ( n + 1 )} \\ γ ( n ) = \frac{α ( n ) ∘ β ( n )}{{α ( n )}^{⊤} β ( n )} . & E \text{-} step \\ π ( {x}_{1} ) = γ ( 1 ) \\ T ( i , k , j ) = {\sum }_{n = 1}^{N} {ξ}_{ikj} ( n ) ∅ {\sum }_{k = 1}^{{N}_{a}} {\sum }_{j = 1}^{E} {\sum }_{n = 1}^{N} {ξ}_{ij} ( n ) . & M \text{-} step\end{matrix}$$

Where N_{α} is the number of action and T(i, k, j)=P(zₙ₊₁, αₙ=k|zₙ) for zₙ₊₁∈hid(j) (i.e., a sub-section of the TPDS).

Optionally, after the EM algorithm converges, determining the final TPDS can include removing unused clones using the Viterbi algorithm which can include using Viterbi decoding (with no pseudocount). Removing unused clones enables the remaining clones to each represent a hidden state of the train environment.

Optionally, learning the final CHMM can include determining a lower-level graph (e.g., directed, undirected, chain, etc.) from the final CHMM.

In a first variant, learning the final CHMM can include converting the final TPDS and/or the final OPDS of the CHMM into a directed graph.

In a second variant, learning the final CHMM can include converting the final TPDS and final OPDS into a chain graph.

In both of the above variants, when the TPDS is action-augmented, the action an and clone or hidden state zₙ₊₁ can be collapsed into a single variable of the directed and/or chain graph.

However, learning the final CHMM can additionally or alternatively include any other suitable elements.

Using the final CHMM S300 functions to perform inference using the final CHMM. Variants of using the final CHMM can be implemented with one or more of the following algorithms: message passing algorithms, sampling algorithms, search algorithms, community detection algorithms, and/or any other suitable algorithms.

The message passing algorithms can function to determine results to queries (e.g., current position of an agent, give a sequence of observations and/or actions from a start position, return to the start position using a most optimal route determined from the final CHMM, such as using a search algorithm described below, etc.). The message passing algorithms can include belief propagation (sum-product message passing), which can calculate the marginal distribution of each unobserved node (or variable or factor), conditional on any observed nodes (or variable or factors) such as from an inference input sequence using the factor graph of the final CHMM. The observed nodes can be: clones (or hidden states), graph nodes (e.g., wherein the graph is determined from a learned TPDS), or other datum. However, the message passing algorithms can additionally or alternatively include any other suitable elements.

The algorithms can include sampling algorithms, which function to generate sequences (e.g., generate plausible observations and actions that would correspond to exploring in a previously learned environment) using the final CHMM. The sampling algorithms can include ancestral sampling, which can include producing samples from the CHMM by first sampling a start hidden state (e.g., pre-determined), then sampling first adjacent hidden states (e.g., adjacency determined based on the final TPDS), then sampling second adjacent hidden states adjacent to the first adjacent hidden states and/so on until a sequence is generated. However, the sampling algorithms can additionally or alternatively include any other suitable elements.

The algorithms can include search algorithms, which function to determine a path in an environment (e.g., train environment, inference environment, etc.). The search algorithms can include Dijkstra's algorithm, beam search, and/or any other suitable search algorithm. However, the search algorithms can additionally or alternatively include any other suitable elements.

The algorithms can include community detection algorithms, which function to determine “communities,” clusters, and/or sub-graphs within a graph (e.g., cluster-aware graphs), wherein each cluster includes densely connected nodes, and each cluster can be sparsely connected to one or more other clusters. Clusters can be overlapping or non-overlapping. The community detection algorithms can include: hierarchical clustering, clique-based methods, modularity maximization, Girvan-Newman algorithm, statistical inference methods that fit a generative model to the graph, and/or any other suitable algorithm. However, the community detection algorithms can additionally or alternatively include any other suitable elements.

In a first variant, the final CHMM can be used for planning to attain goals by performing inference on the final CHMM using message-passing algorithms. A goal (e.g., query parameters) can be specified as a desired observation, as a specific hidden state of that observation (e.g., location or position), and/or any start position and/or end position can be specified. Once the goal is specified, planning can be accomplished by clamping a current hidden state (e.g., clone associated with the start position) at the current time-step, clamping the target hidden state (e.g., associated with the end position) or observation at a future time step and inferring the intermediate sequence of observations, and/or, when the final CHMM is action-augmented, the intermediate sequence of actions. A forward pass of the message passing algorithm can be used to set the goal by determining the feasibility of the goal at each step into the future. A backward pass of the message passing algorithm can determine and return the sequence of observations and/or actions.

In a first specific example, the probability density function of an inference input sequence of observations xᵢ is as follows:

$$P ( {x}_{1} , … , {x}_{N} ) = {\sum }_{{\{ {z}_{n} ∈ hid ( {x}_{n} ) )}_{n = 1}^{N}} P ( {z}_{1} ) {\prod }_{n = 1}^{N - 1} P ( {z}_{n + 1} \vert {z}_{n} ) .$$

where clones zᵢ are associated with observation xᵢ and where zₙ∈hid(xₙ) means the summation is only over the values of zₙ that emit xₙ (the clones of n).

In a second specific example, when the input inference sequence includes actions, the joint observation-action probability density function of an inference input sequence of observations xᵢ and actions αᵢ is as follows:

$$P ( {x}_{1} , … , {x}_{N} , {a}_{1} , … , {a}_{N - 1} ) = {\sum }_{{\{ {z}_{n} ∈ hid ( {x}_{n} ) )}_{n = 1}^{N}} P ( {z}_{1} ) {\prod }_{n = 1}^{N - 1} P ( {z}_{n + 1} \vert {z}_{n} ) .$$

where clones zᵢ are associated with observation xᵢ, and where zₙ∈hid(xₙ) means the summation is only over the values of zₙ that emit xₙ (the clones of xₙ).

In a second variant, the final CHMM can be used for inference. Given an inference input sequence, the final CHMM can be used to determine: the current hidden state (based on the activated clones associated with the prior observations); the probability of transitioning to a given hidden state; the available subsequent hidden states; the availability of next actions; and/or any other suitable information. Additionally, if the final CHMM is action-augmented, but the inference input sequence includes only observations, then the actions can be integrated out of the probability density function. More specifically, when no evidence is available for a given variable, the message passing algorithm will integrate the given variable out of the probability density function.

In a specific example, the final CHMM can be queried to determine which observation is the most likely in the next timestep, or even several timesteps ahead, and the message passing algorithm will produce the exact answer by analytically integrating over all possible past and future actions, and even over the unseen future observations when necessary.

In a third variant, given a start position, an agent can use the final CHMM to explore an inference environment and infer the agent's location (hidden state, zₙ) and optionally predict possible actions from the location, which can be useful for navigation.

In a fourth variant, the final CHMM can be used to condition on a future location to determine an inferred sequence of actions that can take the agent to the future location, and which observations the agent is expected to see after performing each action.

In the above variants, querying can be performed by running a single message passing algorithm on the same final CHMM (without re-training) and only changing the inference input sequence and/or the requested probabilistic predictions, but additionally or alternatively querying can be performed using re-training, using multiple message passing algorithms, and/or querying can be otherwise performed.

In a fifth variant, the final CHMM, more specifically, the final TPDS, can be used to generate sequences (e.g., generate plausible observations and/or actions that correspond to exploring in a train environment) by applying sampling algorithms to the final CHMM.

In a sixth variant, the final CHMM can be used to learn environments with higher-order structure (e.g., nested hierarchies or relationships) in a hierarchical learning process. For example, a graph can be generated from the final CHMM (e.g., the learned TPDS), wherein subgraphs or communities can be detected from the graph. The subgraphs can then be treated as emissions, wherein a second CHMM can be initialized (e.g., as in S100) and learned (e.g., as in S200) based on the same or new train input sequences from the environment to learn the relationships between the subgraphs. An example of hierarchical learning is shown in FIG. 15. However, the higher-order structure can be determined as discussed in the seventh illustrative example, below, or otherwise determined.

However, using the final CHMM can additionally or alternatively include any other suitable elements.

### 5. Illustrative Examples

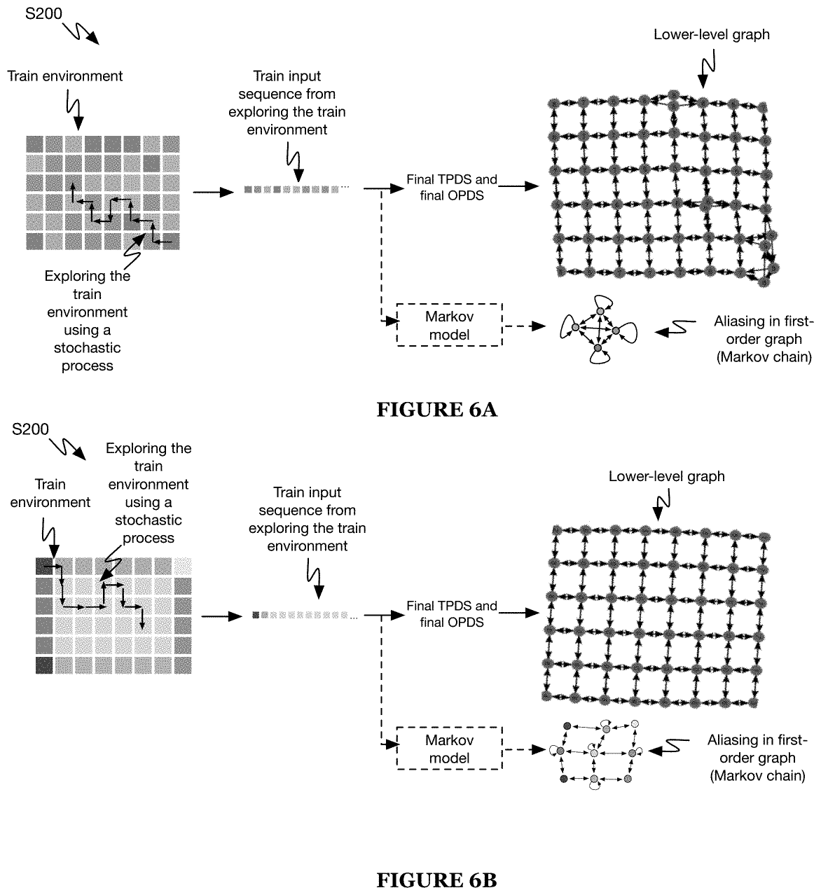

In a first illustrative example, S200 can determine spatial maps (e.g., directed graphs) from aliased sequential observations of one or more train input sequences (e.g., received input sequence) generated from exploring (e.g., stochastic process such as a random walk) particular train environments. Typical first order models can be used to generate first-order graphs that do not adequately determine a spatial map of a particular train environment, as depicted in FIGS. 6A-B. A train environment can include multiple locations, each associated with a potential emission of a set of emissions determined for the train environment. The train input sequence can include multiple observations that map to the same emission, wherein each observation is observed at different locations of the train environment. After determining the final TPDS, the final TPDS can be used to generate a directed graph of the train environment. Specific examples of determining spatial maps are depicted in FIGS. 6A-B.

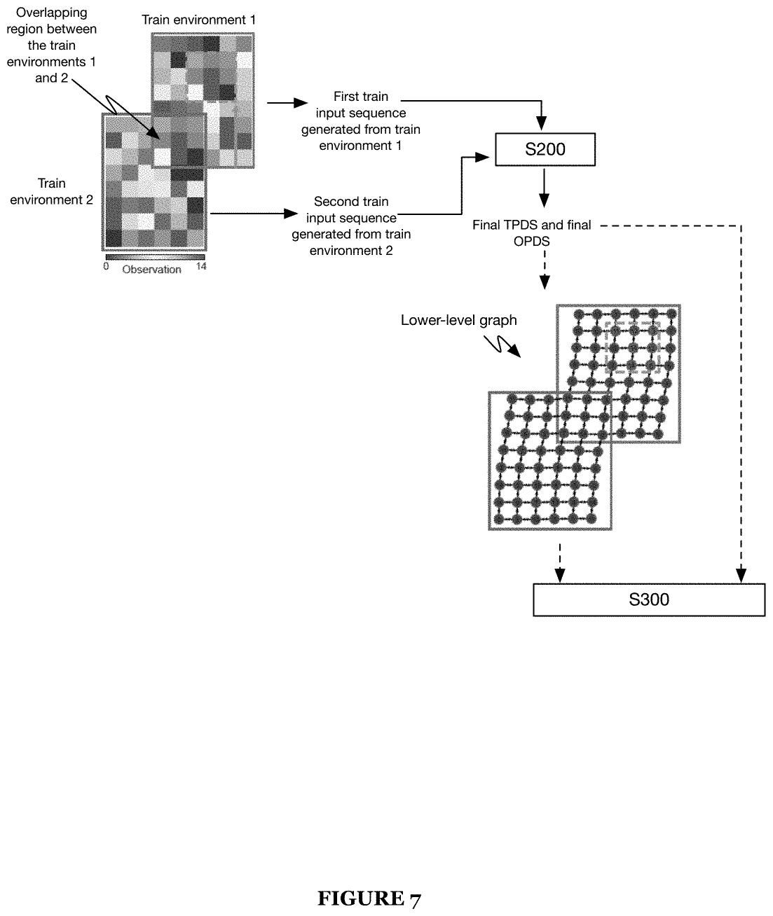

In a second illustrative example, S300 can include using the final CHMM to perform transitive inference, which can include inferring relationships between locations in different environments that were not experienced at the same time during S200 (e.g., using overlapping train environments in S200, such as depicted in FIG. 6). For example, the final CHMM can be determined based on a first and second input sequence, wherein the first input sequence is associated with observations and/or actions from a first train environment, and the second input sequence can be associated with observations and/or actions associated with a second train environment. The final TPDS can assign the same clone to a location that overlaps the different environments, wherein the location was observed in both the first and the second sequences separately. The final TPDS can be used to generate a directed graph, wherein the directed graph stitched the first and the second environments together (e.g., represented overlapping locations with the same clone). A specific example is depicted in FIG. 7.

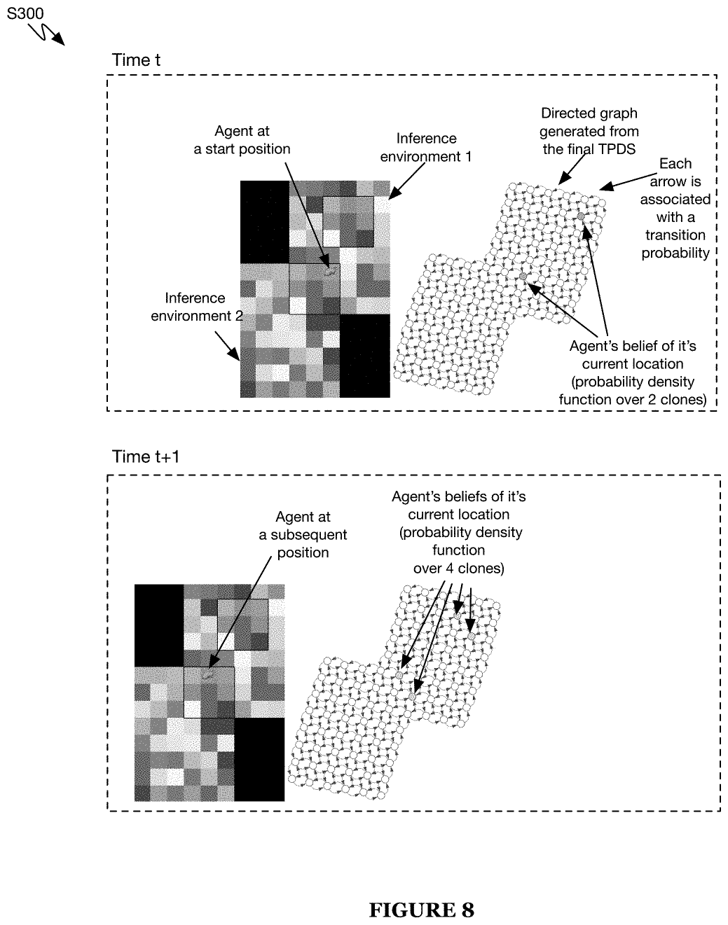

An example of using belief propagation on the previously described directed graph is depicted in FIG. 8. At each timestep, the agent determines a new belief about it's current position using belief propagation (e.g., a forward and backward pass).

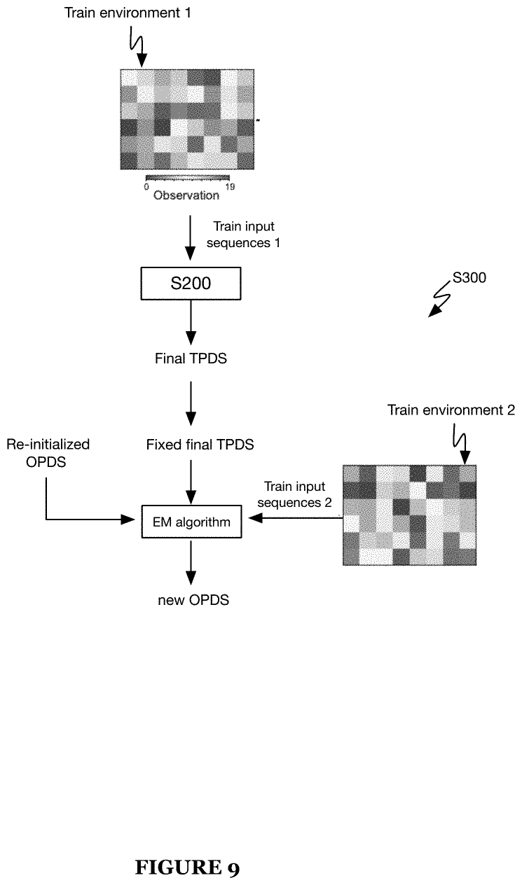

In a third illustrative example, a train environment can be used to generate a final CHMM. A new CHMM can be determined by fixing the final TPDS of the final CHMM, re-initializing the OPDS (e.g., randomly, uniformly, etc.) and learning a new OPDS using the EM algorithm based on inference input sequences. Learning the new OPDS can include partially learning the new OPDS (e.g., based on an inference input sequence including observations and/or actions from a set of locations of all possible locations of a first inference environment). Additionally or alternatively, leaning the new OPDS can include fully learning the new OPDS (e.g., performing the EM algorithm until convergence, visiting all locations of the first inference environment, etc.). A variant of the previously described illustrative example is depicted in FIG. 9.

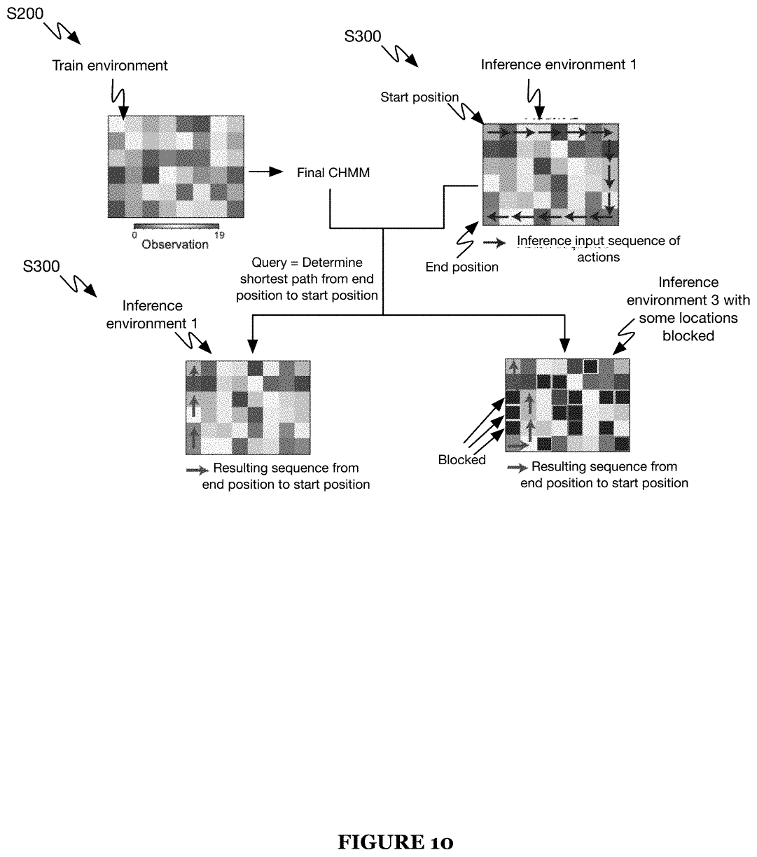

The fixed TPDS and the new OPDS cooperatively form the new CHMM, which can be used for inference, such as to query the new CHMM for a return path (e.g., sequence of actions and/or a sequence of observations) from a specified end position to a specified start position of a second inference environment, or otherwise used (e.g., as discussed in S300). The second inference environment can include the same number and organization of locations as the first inference environment, but can additionally or alternatively include fewer (e.g., blocked) locations than the first inference environment. The second inference environment can be the first inference environment with the same observations associated with each location and/or different observations associated with each location (and/or a subset thereof). A specific example is depicted in FIG. 10.

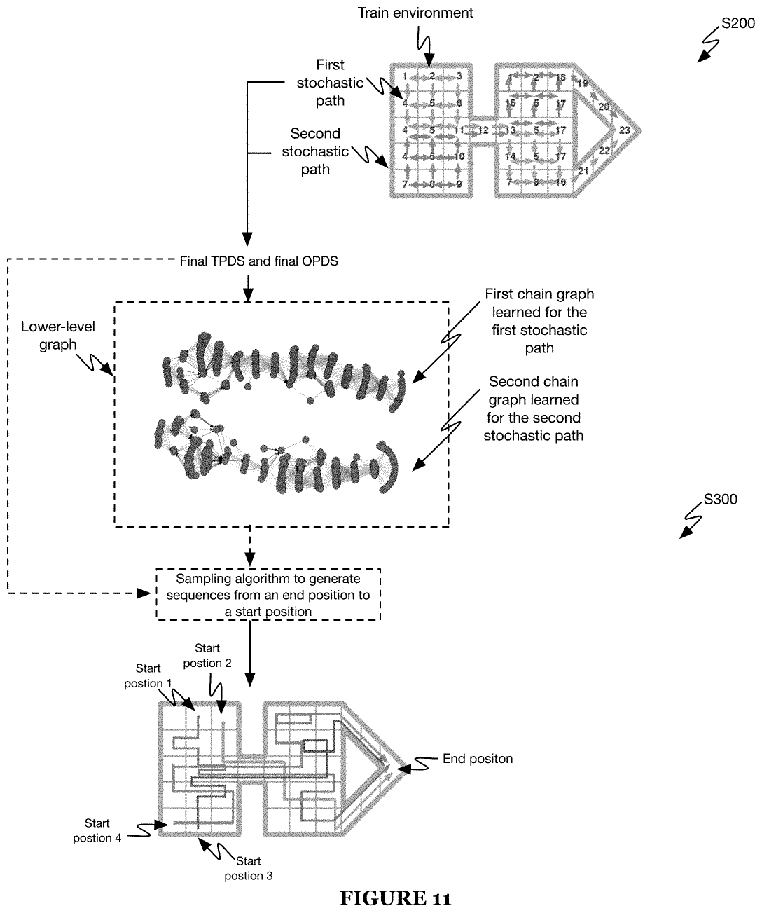

In a fourth illustrative example, a first and second stochastic path can be determined from a train environment, wherein the paths can overlap and/or not overlap. A final CHMM can be determined in S200 based on both the first and second stochastic paths received as train input sequences (e.g., including actions). The first and second stochastic paths can be used by S200 in series or in parallel. The final CHMM determined by S200 can include a lower-level graph, a final TPDS, and/or a final OPDS, wherein different clones are used to represent overlapping portions of the first and second stochastic paths. A specific example is depicted in FIG. 11.

The final CHMM can be used to generate sequences from an end position to a start position and/or from a start position to an end position using sampling algorithms. A specific example is depicted in FIG. 11.

In a fifth illustrative example, the final CHMM can model temporal information using community detection algorithms. A train input sequence can include observations associated with “laps” around a training environment wherein after a certain number of laps, the agent can receive a reward, which can be represented in the input sequence (e.g., real-valued number, character, etc.). The final CHMM can distinguish between the different “laps” by assigning different clones to the same location experienced at different time steps. A specific example is depicted in FIG. 12.

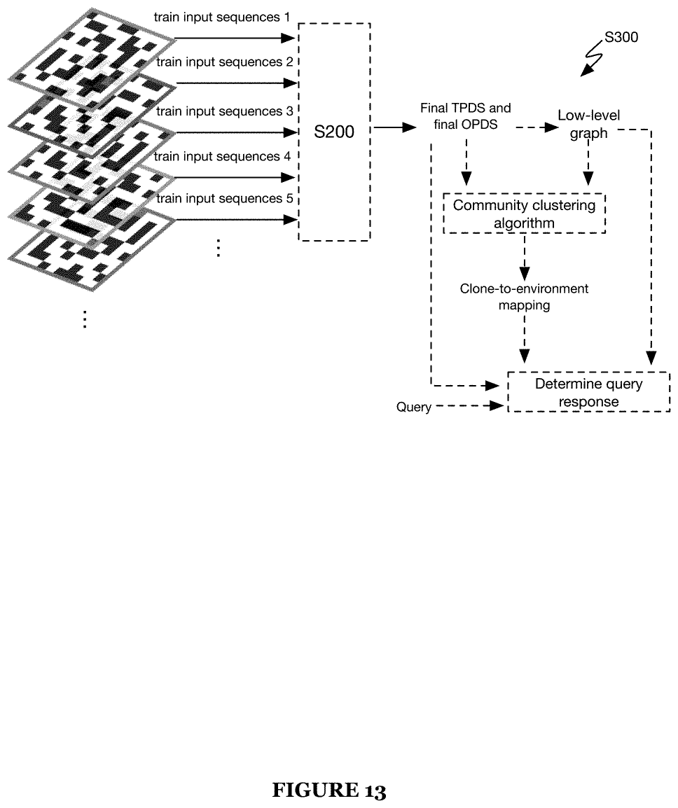

In a sixth illustrative example, multiple different environments are used to generate train input sequences for S200. The set of emissions for each of the multiple different environments can be the same, but can additionally or alternatively be different per environment. The final TPDS and/or final OPDS can be used to generate a low-level graph. The final TPDS, final OPDS, and/or the low-level graph can be used by a community clustering algorithm to determine a clone-to-environment mapping. The final TPDS, final OPDS, the low-level graph, and/or the clone-to-environment mapping can be used to determine query responses using one or more of the algorithms of S300. In a first variant, after determining the final TPDS and OPDS, forward messages can be determined and the sum of forward messages of sum-product belief propagation for each train environment can be used to generate a distribution over the locations (hidden states) of each train environment. Then, using an inference input sequence generated from the train environments, the forward messages and the clone distributions per train environment can be used to infer the probability of being in each train environment at each timestep. An example of the previously described illustrative example is depicted in FIG. 13.

In a seventh illustrative example, the final CHMM can represent hierarchical information by receiving input train sequences in S200 associated with a train environment that is hierarchical. The train environment can be used to determine a final CHMM in S200. The final TPDS and/or OPDS can be used to generate a cluster-aware graph using community clustering algorithms. The cluster-aware graph, the final TPDS, and/or the final OPDS can be used to determine a hierarchical grouping of the clusters of the cluster-aware graph, wherein the edges of the hierarchical grouping that represent a path between the clusters of the cluster-aware graph can be directed and/or undirected. S300 can include path planning by first determining a start cluster associated with a received start position and an end cluster associated with a received end position using the cluster-aware graph, wherein the start and end positions are received as query parameters. The start cluster and the end cluster can be used to reduce the search space in the lower-level graph, wherein the lower-level graph can be used to determine the sequence between the end position to the start position. A specific example is depicted inf FIG. 14.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A system comprising a processing system, the processing system comprising:
a set of potential emissions;
a hardcoded observation array, comprising:
a different set of clones for each potential emission, wherein the different sets of clones cooperatively form a plurality of clones;
a set of emission probabilities relating each clone of the plurality to each potential emission, each emission probability representing a probability of observing the potential emission from the clone; and
a transition array, comprising:
a set of transition probabilities representing a probability of transitioning from a current clone to another clone of the plurality of clones, wherein the set of transition probabilities is determined by fixing the hardcoded observation array and updating the set of transition probabilities based on a set of received observations, wherein each observation of the set of received observations is an observation of an emission from the set of potential emissions.

2. The system of claim 1, wherein the set of received observations is received from a sensor mounted to an agent.

3. The system of claim 1, wherein the observation array is sparse.

4. The system of claim 1, further comprising a plurality of potential actions, wherein the system is configured to determine an action from the plurality of potential actions based on a current clone of the plurality of clones.

5. The system of claim 4, further configured to determine a subsequent clone for a subsequent timestep based on the current clone and a received action.

6. The system of claim 4, wherein the transition array comprises three dimensions, wherein a first and a second dimension of the three dimensions are each associated with the plurality of clones, and wherein a third dimension is associated with the plurality of potential actions.

7. The system of claim 4, wherein updating the set of transition probabilities comprises updating a subarray of the transition array, wherein the subarray is determined based a set of indices associated with a set of clones corresponding to a potential emission associated with a received observation and an action of a plurality of received actions.

8. The system of claim 1, wherein the observation array is overcomplete.

9. The system of claim 8, wherein each potential emission of the set of potential emissions is associated with a number of hidden states, wherein a number of clones in a set of clones associated with a potential emission is larger than the number of hidden states associated with the potential emission.

10. The system of claim 1, wherein the set of received observations comprises aliased observations.

11. The system of claim 1, wherein an emission probability of the set of emission probabilities is determined based on sensor noise.

12. A method comprising:
determining a set of potential emissions;
determining a hardcoded observation array, comprising:
assigning a different set of clones to each potential emission, wherein the different sets of clones cooperatively form a plurality of clones;
determining a set of emission probabilities relating each clone to a potential emission; and
determining a transition array, comprising:
determining a set of transition probabilities;
fixing the hardcoded observation array; and
updating the set of transition probabilities using the fixed hardcoded observation array based on a set of received observations, wherein each of the received observations is an observation of an emission from the set of potential emissions.

13. The method of claim 12, wherein the transition array represents higher-order sequences that encode temporal contexts in a first order model.

14. The method of claim 12, wherein received observations within the set of received observations are observed from different environments.

15. The method of claim 12, further comprising determining a sequence of observations and associated actions to transition from a first clone to a second clone, comprising:
clamping the first clone at a first timestep;
clamping the second clone at a subsequent timestep; and
using a backward pass of a message passing algorithm from the second clone to the first clone to determine the sequence of observations.

16. The method of claim 15, wherein the cloned hidden Markov model is a first order model.

17. The method of claim 15, wherein the set of transition probabilities is determined using an expectation-maximization (EM) algorithm.

18. The method of claim 17, wherein the using the expectation-maximization (EM) algorithm comprises using a Baum-Welch algorithm.

19. The method of claim 12, wherein the set of transition probabilities is associated with a set of potential actions, wherein the set of potential actions define a third dimension within the transition array, and wherein updating the set of transition probabilities further comprises updating the transition probabilities based on a set of received actions, wherein each received action is from the set of potential actions and is associated with a received observation.

20. The method of claim 12, wherein the set of emission probabilities is determined based on sensor noise.
